(19) United States
(12) Patent Application Publication
(10) Pub. No.: US 2026/0022598 A1
(43) Pub. Date: Jan. 22, 2026

(54) DEVICE FOR SECURING DOORS, DOOR SYSTEMS, AND RELATED METHODS

(71) Applicant: Q SECURITY, LLC, Nicholasville, KY (US)

(72) Inventors: J. Clayton Miller, Nicholasville, KY (US); Michael J. Osborne, Lancaster, KY (US); Paul Scherer, Lexington, KY (US)

(21) Appl. No.: 19/267,801

(22) Filed: Jul. 14, 2025

Related U.S. Application Data
(60) Provisional application No. 63/671,838, filed on Jul. 16, 2024.
(60) Provisional application No. 63/816,135, filed on Jun. 2, 2025.

(51) Int. Cl. E05C 19/00; E05B 65/06

(52) U.S. Cl. CPC E05C 19/003; E05B 65/06

(57) ABSTRACT

A device for securing a door including a blocking member and an emergency actuator. The blocking member is configured to be located adjacent to the door and to move between a blocking member unsecured orientation and a blocking member secured orientation. The door is free to open and close when the blocking member is in the blocking member unsecured orientation. The blocking member moves from the blocking member unsecured orientation to the blocking member secured orientation when the emergency actuator is actuated. The door is prevented from opening when the blocking member is in the blocking member secured orientation.

### CROSS REFERENCE TO RELATED APPLICATION

This application claims the priority of U.S. Provisional Patent Application Ser. No. 63/671,838, filed on Jul. 16, 2024 (pending), and U.S. Provisional Patent Application Ser. No. 63/816,135 filed on Jun. 2, 2025 (pending), the disclosures of which are incorporated herein by reference in their entirety.

### TECHNICAL FIELD

The present disclosure generally relates to devices for preventing the operation of and securing doors in a closed position and related methods.

### BACKGROUND

For safety and security reasons, sometimes doors may need to be secured quickly in an emergency. For example, a door may need to be secured to allow time for people to escape potentially dangerous situations. Alternatively, a door may need to be secured to provide a safe and secure area for people to shelter during a dangerous situations.

Double acting doors are a special type of door designed to swing open in two directions, in and out. On the other hand, a single acting door will swing only in or out relative to the space being accessed by the door. A double acting door always swings away from the person or load passing through it, allowing for easy and safe passage. For example, double acting hinges allow double acting doors to swing in two directions and automatically return the doors to the closed position. Restaurant kitchens, grocery stores, warehouses, shipping and receiving areas, and storage facilities commonly use double acting doors. Double acting doors are often used in high-traffic areas or in a location where it is not practical to have a door that opens in only one direction. They are also used in institutions that require a door to open in both directions in the case of emergencies, such as hospitals, clinics, nursing homes, correctional facilities, and government facilities.

Double acting doors offer a unique challenge for quickly securing the doors. Because double acting doors can swing in either direction, a lock that prevents bidirectional movement is required. Additionally, many double acting doors are light and flexible interior doors that are not designed to be secured. Currently, many systems for securing doors involve placing a lock directly on the door and moving a deadbolt into a latch bore on the door frame to secure the door. Drawbacks of this method are readily apparent. For example, some doors are too light, thin, or lack the rigidity, i.e. are too flexible, to mount a lock directly to the door. Additionally, the time it takes to align a swinging door with a latch bore makes the lock slow to operate and is not suitable for an emergency situation. This makes the currently available double acting door lock systems impractical for applications where a double acting door may need to be secured quickly. For example, employees working in retail or service spaces may need to quickly secure a double acting door to allow time to escape potentially dangerous situations. Other methods of securing double acting doors involve the use of barricade bars that extend across the width of the door frame and latch on the door and/or the door frame. Barricade bars have the drawbacks of being slow to use and may require significant effort to secure.

### SUMMARY

A device for securing a door is provided. The device includes a blocking member and an emergency actuator. The blocking member is configured to be located adjacent to the door and to move between a blocking member unsecured orientation and a blocking member secured orientation. The door is free to open and close when the blocking member is in the blocking member unsecured orientation. The blocking member moves from the blocking member unsecured orientation to the blocking member secured orientation when the emergency actuator is actuated. The door is prevented from opening when the blocking member is in the blocking member secured orientation.

In some embodiments, the blocking member secured orientation may include a plurality of blocking member secured orientations. The device may include a security latch associated with the blocking member. When activated, the security latch may maintain the blocking member in the blocking member secured orientation. Moving the blocking member into the blocking member secured orientation may activate the security latch. Releasing the security latch may allow the blocking member to be moved from the blocking member secured orientation to the blocking member unsecured orientation. The device may include a security latch release actuator associated with the security latch and configured to release the security latch when the security latch release actuator is actuated. The device may include a lock mechanism associated with the security latch and configured to release the security latch when the lock mechanism is actuated. The lock mechanism may include a keyed lock.

In alternative or additional aspects, the security latch may include a ratchet and a pawl configured to engage the ratchet. Moving the blocking member from the blocking member unsecured orientation to the blocking member secured orientation may rotate the ratchet in a first ratchet direction and the pawl may engage the ratchet preventing the ratchet from rotating in a second ratchet direction, the second ratchet direction being opposite the first ratchet direction, which may prevent the blocking member from moving to the blocking member unsecured orientation. Disengaging the pawl from the ratchet may allow the ratchet to rotate in the second ratchet direction which may allow the blocking member to be moved to the blocking member unsecured orientation. The emergency actuator may include an emergency actuator latch. The emergency actuator latch may maintain the blocking member in the blocking member unsecured orientation. Actuating the emergency actuator may release the emergency actuator latch allowing the blocking member to move to the blocking member secured orientation.

In alternative embodiments, the device may include a force biasing device configured to bias the blocking member to the blocking member secured orientation. The force biasing device may include a spring. The device may include at least one of a sensor or a switch configured to send a signal to an alarm system when the blocking member is in the blocking member secured orientation. The blocking member may be a first blocking member configured to be located adjacent to a first side of the door and to move between a first blocking member unsecured orientation and a first blocking member secured orientation. The device may include a second blocking member configured to be located adjacent to a second side of the door and to move between a second blocking member unsecured orientation and a second blocking member secured orientation. The door may be free to open and close when the first blocking member is in the first blocking member unsecured orientation and the second blocking member is in the second blocking member unsecured orientation. The door may be prevented from opening when the first blocking member is in the first blocking member secured orientation and the second blocking member is in the second blocking member secured orientation.

An alternative device for securing a door is provided. The alternative device includes a first blocking member and a second blocking member. The first blocking member is configured to be located adjacent to a first side of the door and to move between a first blocking member unsecured orientation and a first blocking member secured orientation. The second blocking member configured to be located adjacent to a second side of the door and to move between a second blocking member unsecured orientation and a second blocking member secured orientation. The door is free to open and close when the first blocking member is in the first blocking member unsecured orientation and the second blocking member is in the second blocking member unsecured orientation. The door is prevented from opening when the first blocking member is in the first blocking member secured orientation and the second blocking member is in the second blocking member secured orientation.

In some embodiments, the first blocking member secured orientation may include a plurality of first blocking member secured orientations. The second blocking member secured orientation may include a plurality of second blocking member secured orientations. The device may include a security latch associated with at least one of the first blocking member or the second blocking member. When activated, the security latch may maintain at least one of the first blocking member in the first blocking member secured orientation or the second blocking member in the second blocking member secured orientation. Moving at least one of the first blocking member into the first blocking member secured orientation or the second blocking member into the second blocking member secured orientation may activate the security latch. Releasing the security latch may allow at least one of the first blocking member to be moved from the first blocking member secured orientation to the first blocking member unsecured orientation or the second blocking member to be moved from the second blocking member secured orientation to the second blocking member unsecured orientation. The device may include a security latch release actuator associated with the security latch and configured to release the security latch when the security latch release actuator is actuated. The device may include a lock mechanism associated with the security latch and configured to release the security latch when the lock mechanism is actuated. The lock mechanism may include a keyed lock.

In alternative or additional aspects, the security latch may include a ratchet and a pawl configured to engage the ratchet. Moving at least one of the first blocking member from the first blocking member unsecured orientation to the first blocking member secured orientation or the second blocking member from the second blocking member unsecured orientation to the second blocking member secured orientation may rotate the ratchet in a first ratchet direction and the pawl may engage the ratchet preventing the ratchet from rotating in a second ratchet direction, the second ratchet direction being opposite the first ratchet direction, which may prevent at least one of the first blocking member from moving to the first blocking member unsecured orientation or the second blocking member from moving to the second blocking member unsecured orientation. Disengaging the pawl from the ratchet may allow the ratchet to rotate in the second ratchet direction which may allow at least one of the first blocking member to be moved to the first blocking member unsecured orientation or the second blocking member to be moved to the second blocking member unsecured orientation. The device may include an emergency actuator associated with the first blocking member and the second blocking member. The first blocking member may move from the first blocking member unsecured orientation to the first blocking member secured orientation and the second blocking member may move from the second blocking member unsecured orientation to the second blocking member secured orientation when the emergency actuator is actuated. The emergency actuator may include an emergency actuator latch. The emergency actuator latch may maintain at least one of the first blocking member in the first blocking member unsecured orientation or the second blocking member in the second blocking member unsecured orientation and actuating the emergency actuator may release the emergency actuator latch allowing at least one of the first blocking member to move to the first blocking member secured orientation or the second blocking member to move to the second blocking member secured orientation.

In alternative embodiments, the device may include a force biasing device configured to bias at least one of the first blocking member to the first blocking member secured orientation or the second blocking member to the second blocking member secured orientation. The force biasing device may include a spring. The device may include at least one of a sensor or a switch configured to send a signal to an alarm system when at least one of the first blocking member is in the first blocking member secured orientation or the second blocking member is in the second blocking member secured orientation.

Another alternative device for securing a door is provided. The alternative device includes a first blocking member, a second blocking member, an emergency actuator, and a security latch. The first blocking member is configured to be located adjacent to a first side of the door and to move between a first blocking member unsecured orientation and a first blocking member secured orientation. The second blocking member is configured to be located adjacent to a second side of the door and to move between a second blocking member unsecured orientation and a second blocking member secured orientation. The emergency actuator is associated with the first blocking member and the second blocking member. The security latch is associated with the first blocking member and the second blocking member. The door is free to open and close when the first blocking member is in the first blocking member unsecured orientation and the second blocking member is in the second blocking member unsecured orientation. The first blocking member moves from the first blocking member unsecured orientation to the first blocking member secured orientation and the second blocking member moves from the second blocking member unsecured orientation to the second blocking member secured orientation when the emergency actuator is actuated. The door is prevented from opening when the first blocking member is in the first blocking member secured orientation and the second blocking member is in the second blocking member secured orientation. Moving the first blocking member into the first blocking member secured orientation and the second blocking member into the second blocking member secured orientation activates the security latch and the security latch maintains the first blocking member in the first blocking member secured orientation and the second blocking member in the second blocking member secured orientation. Releasing the security latch allows the first blocking member to be moved from the first blocking member secured orientation to the first blocking member unsecured orientation and the second blocking member to be moved from the second blocking member secured orientation to the second blocking member unsecured orientation.

In some embodiments, the first blocking member secured orientation may include a plurality of first blocking member secured orientations. The second blocking member secured orientation may include a plurality of second blocking member secured orientations. The device may include a security latch release actuator associated with the security latch and configured to release the security latch when the security latch release actuator is actuated. The device may include a lock mechanism associated with the security latch and configured to release the security latch when the lock mechanism is actuated. The lock mechanism may include a keyed lock.

In alternative or additional aspects, the security latch may include a ratchet and a pawl configured to engage the ratchet. Moving at least one of the first blocking member from the first blocking member unsecured orientation to the first blocking member secured orientation or the second blocking member from the second blocking member unsecured orientation to the second blocking member secured orientation may rotate the ratchet in a first ratchet direction and the pawl may engage the ratchet preventing the ratchet from rotating in a second ratchet direction, the second ratchet direction being opposite the first ratchet direction, which may prevent at least one of the first blocking member from moving to the first blocking member unsecured orientation or the second blocking member from moving to the second blocking member unsecured orientation. Disengaging the pawl from the ratchet may allow the ratchet to rotate in the second ratchet direction which may allow at least one of the first blocking member to be moved to the first blocking member unsecured orientation or the second blocking member to be moved to the second blocking member unsecured orientation.

The emergency actuator may include an emergency actuator latch. The emergency actuator latch may maintain at least one of the first blocking member in the first blocking member unsecured orientation or the second blocking member in the second blocking member unsecured orientation and actuating the emergency actuator may release the emergency actuator latch allowing at least one of the first blocking member to move to the first blocking member secured orientation or the second blocking member to move to the second blocking member secured orientation.

In alternative embodiments, the device may include a force biasing device configured to bias at least one of the first blocking member to the first blocking member secured orientation or the second blocking member to the second blocking member secured orientation. The force biasing device may include a spring. The device may include at least one of a sensor or a switch configured to send a signal to an alarm system when at least one of the first blocking member is in the first blocking member secured orientation or the second blocking member is in the second blocking member secured orientation.

A method of securing a door is provided. The method includes moving a first blocking member located adjacent to a first side of the door to a first blocking member secured orientation and moving a second blocking member located adjacent to a second side of the door to a second blocking member secured orientation. The method also included activating a security latch thereby securing the first blocking member in the first blocking member secured orientation and the second blocking member in the second blocking member secured orientation. The door is prevented from opening when the first blocking member is in the first blocking member secured orientation and the second blocking member is in the second blocking member secured orientation.

In some embodiments, the first blocking member secured orientation may include a plurality of first blocking member secured orientations. The second blocking member secured orientation may include a plurality of second blocking member secured orientations. The method may include releasing an emergency actuator latch which may allow the first blocking member to move to the first blocking member secured orientation and the second blocking member to move to the second blocking member secured orientation. The method may include releasing the security latch which may allow the first blocking member to be moved to a first blocking member unsecured orientation and the second blocking member to be moved to a second blocking member unsecured orientation. The door may be free to open and close when the first blocking member is in the first blocking member unsecured orientation and the second blocking member is in the second blocking member unsecured orientation. The method may include sending a signal to an alarm system when the first blocking member is in the first blocking member secured orientation and the second blocking member is in the second blocking member secured orientation.

### BRIEF DESCRIPTION OF THE DRAWINGS

FIGS. 1 and 2 are perspective views of an illustrative door assembly in a closed position and an illustrative security device in an unsecured condition and first and second blocking members in an unsecured orientation.

FIGS. 3 and 4 are perspective views of the door assembly and security device of FIGS. 1 and 2 with the security device in a secured condition and the first and second blocking members in a secured orientation.

FIGS. 5 and 6 are detailed perspective views of the security device of FIGS. 1 and 2 with the first and second blocking members in the unsecured orientation.

FIGS. 7 and 8 are detailed perspective views of the security device of FIGS. 1 and 2 with the first and second blocking members in between the unsecured orientation and a secured orientation.

FIG. 9 is a perspective view of a portion of the security device of FIGS. 1 and 2 in the unsecured condition.

FIG. 10 is a perspective view of a portion of the security device of FIGS. 1 and 2 in a secured condition.

FIG. 11 is a top view of an emergency actuator of the security device of FIGS. 1 and 2.

FIGS. 12, 13, and 14 are elevation views of a portion of the security device of FIGS. 1 and 2 showing the progressive operation of a security latch.

FIG. 15 is an elevation view of a portion of the security device of FIGS. 1 and 2 showing the security latch being released.

FIG. 16 is a perspective view of a stop bracket configured to hold the first and second blocking members of the security device of FIGS. 1 and 2 in the unsecured orientation until activated by a user.

FIG. 17 is a perspective view of an illustrative door assembly in a closed position and an alternative illustrative security device in an unsecured condition.

FIGS. 18 and 19 are partial perspective views of the door assembly in a closed position and the security device of FIG. 17 in the unsecured condition.

FIG. 20A is a partial perspective view of the door assembly illustrating the security device of FIG. 17 moving from the unsecured condition to a secured condition.

FIG. 20B is a partial perspective view of the door assembly with the security device of FIG. 17 in a secured condition.

FIG. 21A is a partial perspective view of the door assembly illustrating the security device of FIG. 17 moving from the unsecured condition to a secured condition.

FIG. 21B is a partial perspective view of the door assembly with the security device of FIG. 17 in a secured condition.

FIGS. 22 and 23 are detailed perspective views of the security device of FIG. 17 with first and second blocking members in an unsecured orientation.

FIG. 24 is a section view of the security device of FIG. 17.

FIG. 25 is a partial section view of the security device of FIG. 17.

FIG. 26 is an elevation view of a portion of the security device of FIG. 17.

FIGS. 27, 28, 29, and 30 are partial elevation views of a portion of the security device of FIG. 17 detailing portions of a latch release mechanism.

### DETAILED DESCRIPTION OF THE ILLUSTRATIVE EMBODIMENTS

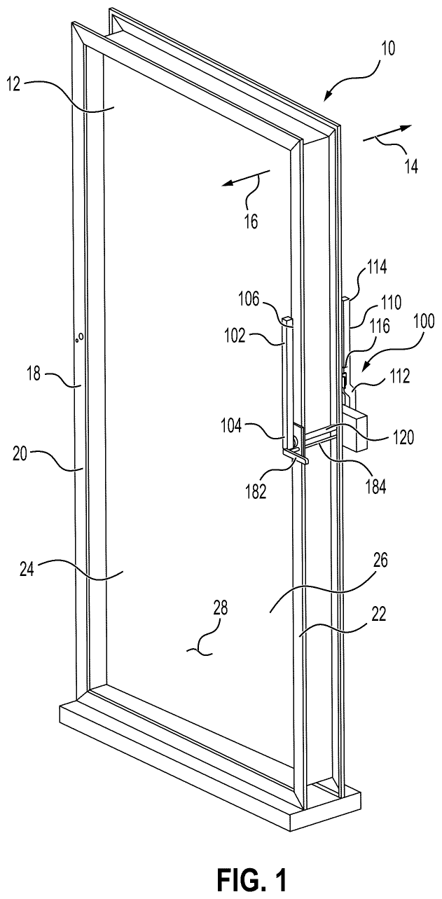

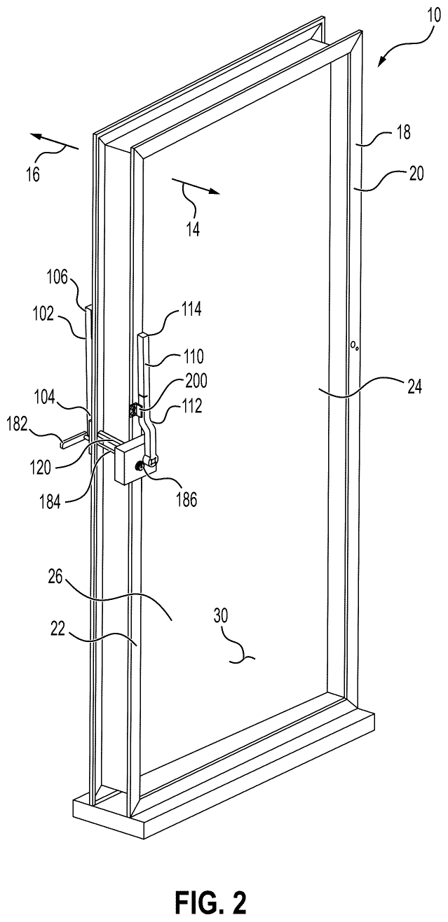

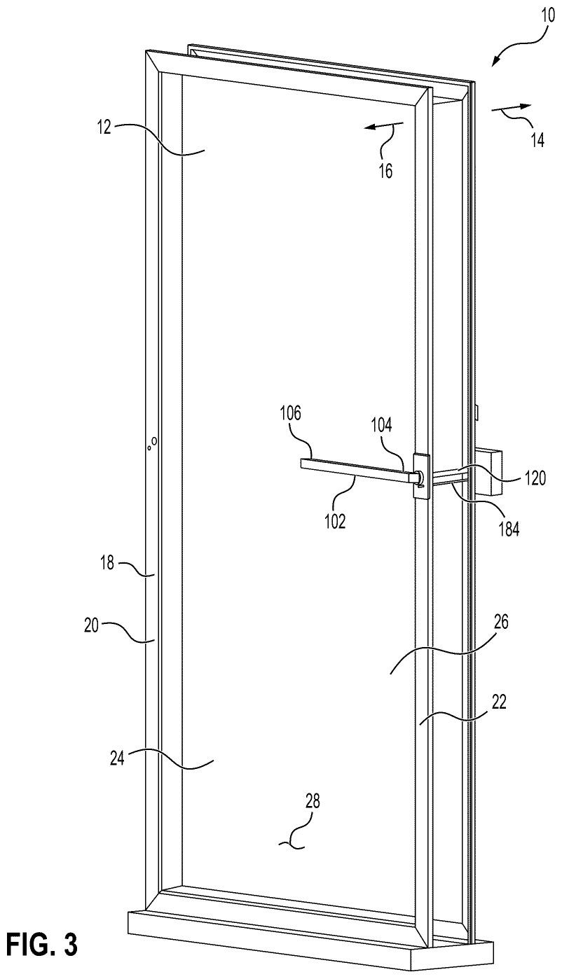

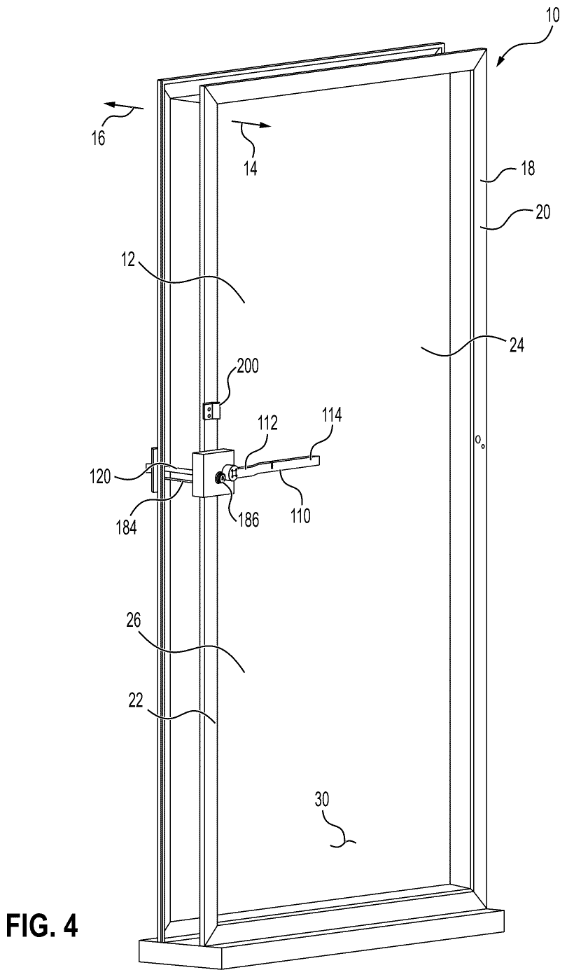

FIGS. 1 and 2 are perspective views of an illustrative door assembly 10 in a closed position and an illustrative security device 100 in an unsecured condition. In this illustrative embodiment, the security device 100 is shown installed on a double acting door, however, it will be appreciated that the general concepts disclosed herein are applicable in various forms to either single or double acting doors. The security device 100 allows normal operation of a door 12, i.e. the door 12 is free to swing open in two directions, indicated by arrows 14 and 16, and return to the closed position when the security device 100 is in the unsecured condition. In addition to the door 12, the door assembly 10 includes a door frame 18 with a hinge side 20 and a non-hinge side 22. The door 12 includes a hinge side 24, a non-hinge side 26, a first side or secure side 28 and a second side or unsecure side 30. FIGS. 3 and 4 are perspective views of the door assembly 10 with the security device 100 in a secured condition. The security device 100 maintains the door 12 in the closed position and prevents the door 12 from opening when the security device 100 is in the secured condition.

In this illustrative embodiment, the security device 100 is mounted adjacent to the door 12 on the non-hinge side 22 of the door frame 18. In many applications the door frame 18 is constructed of steel making the door frame 18 a preferred mounting location for the security device 100. In some embodiments, the wall adjacent to the door 12 may be constructed of a structurally rigid material such as wood, brick or block masonry and the security device 100 may be mounted to the wall adjacent to the door 12.

The unsecure side 30 of the door 12 may refer to the side of the door 12 that faces an area of a building that is open to the public such as the dining area or retail space of a restaurant or coffee shop, for example. The secure side 28 of the door 12 may refer to the side of the door 12 that faces an area of a building that is not open to the public such as a kitchen or office area, for example. When the security device 100 is in the secured condition, the door 12 is maintained in the closed position and people are prevented from readily accessing the area on the secure side 28 of the door 12. In an emergency situation, such as an active shooter event, employees and customers, for example, may go to the secure side 28 of the door 12 and secure the door 12 by activating the security device 100. The employees and customers would then be in a safe place from the danger and may have additional time to further escape the building through a back door, for example.

The security device 100 includes a first blocking member 102 located on the secure side 28 of the door 12 and a second blocking member 110 located on the unsecure side 30 of the door 12. The first and second blocking members 102, 110 are configured to move between an unsecured orientation as shown in FIGS. 1 and 2 and a secured orientation as shown in FIGS. 3 and 4.

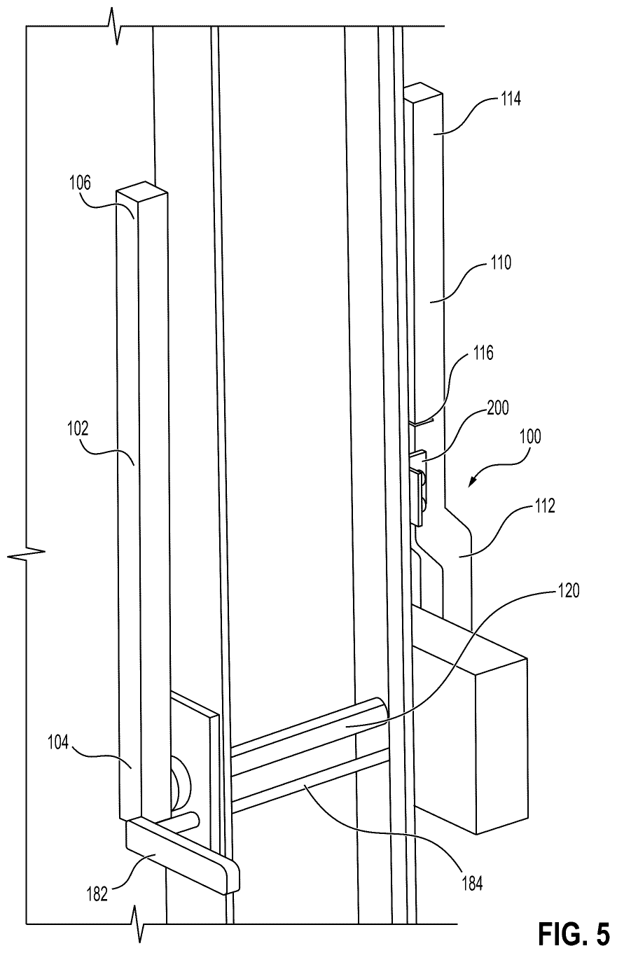

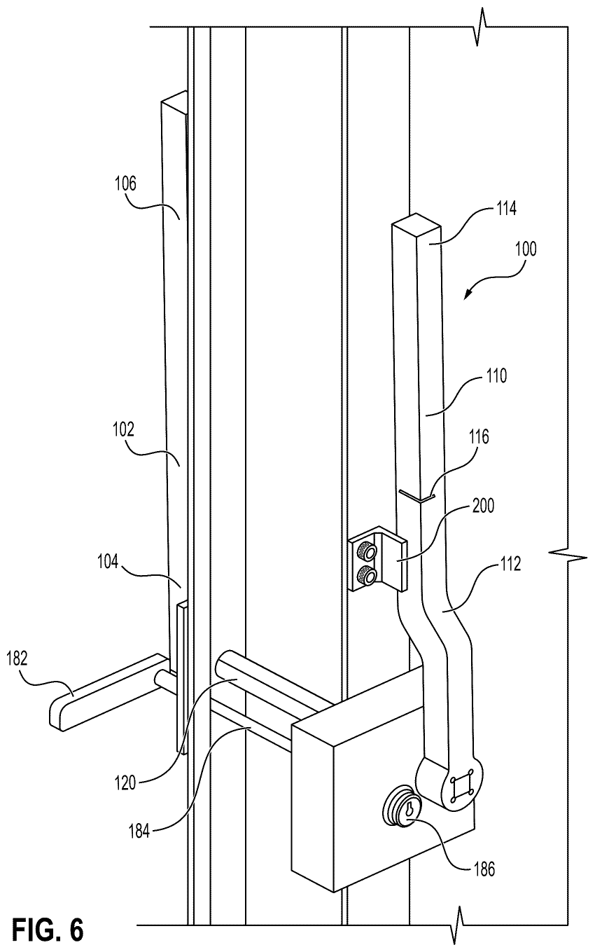

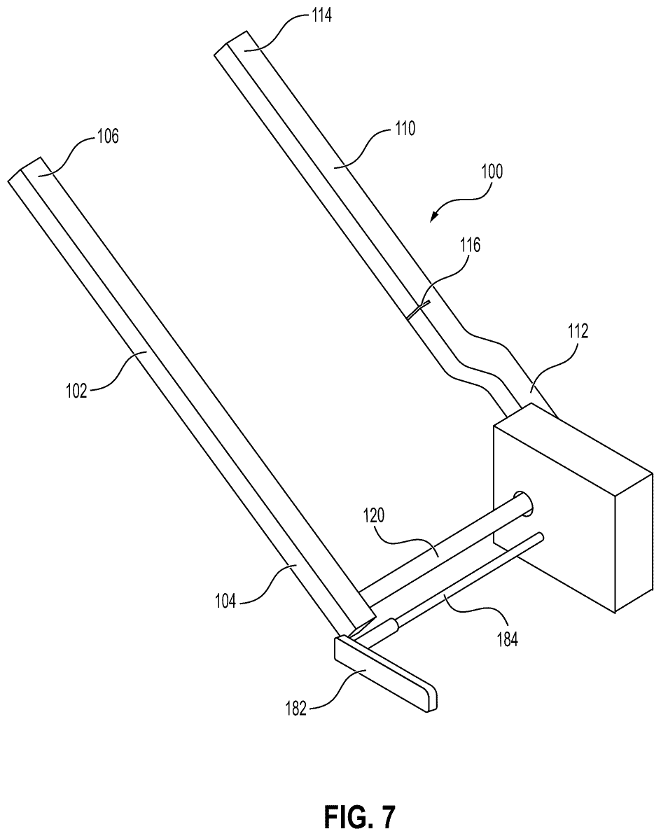

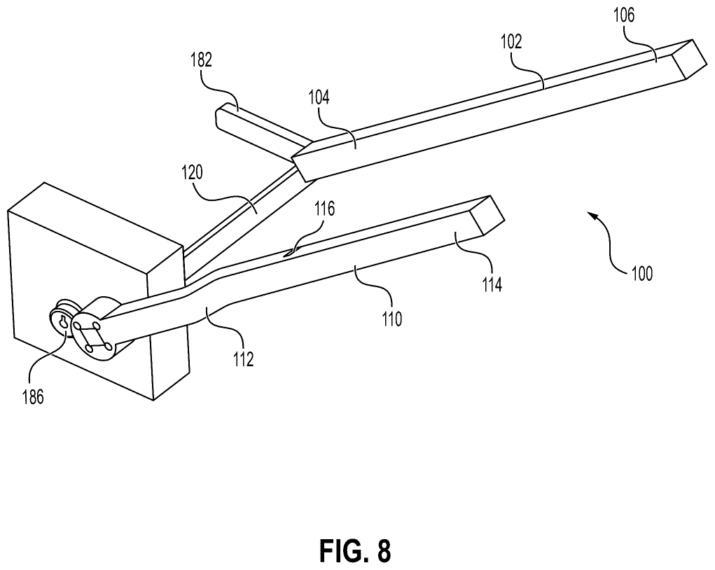

FIGS. 5 and 6 are perspective views of the security device 100 with the first and second blocking members 102, 110 in the unsecured orientation. FIGS. 7 and 8 are perspective views of the security device 100 with the first and second blocking members 102, 110 in between the unsecured orientation and the secured orientation. For ease of reference, portions of the door assembly 10 have been omitted from FIGS. 5-8. The first blocking member 102 has a proximal end portion 104 and a distal end portion 106. The second blocking member 110 has a proximal end portion 112 and a distal end portion 114. The proximal end portion 104 of the first blocking member 102 is coupled to the proximal end portion 112 of the second blocking member 110 by a blocking member shaft 120. The blocking member shaft 120 passes through the door frame 18 and/or the wall adjacent to the door 12. The second blocking member 110 has a breakaway notch 116. The breakaway notch 116 located between the distal end portion 114 of the second blocking member 110 and the non-hinge side 26 of the door 12 when the second blocking member 110 is in the secured orientation. The breakaway notch 116 is configured to allow the distal end portion 114 of the second blocking member 110 to bend or break away from the remainder of the second blocking member 110 if someone were to pull on the distal end portion 114 of the second blocking member 110, for example. The breakaway notch 116 allows the remainder of the second blocking member 110 to maintain the door 12 in the closed position.

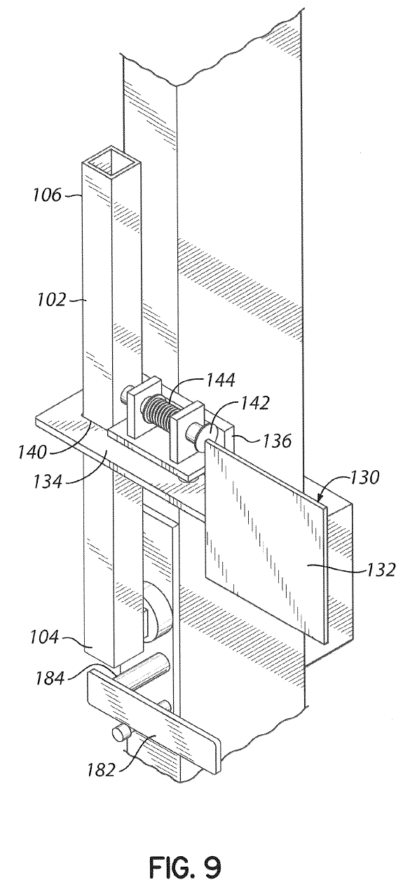

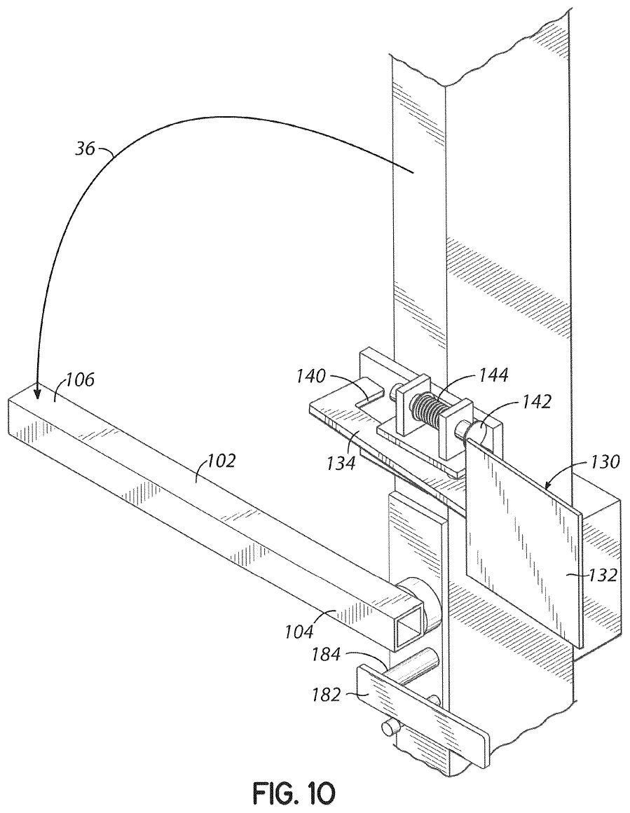

FIG. 9 is a perspective view of a portion of the security device 100 in the unsecured condition, see FIGS. 1 and 2. FIG. 10 is a perspective view of a portion of the security device 100 in a secured condition, see FIGS. 3 and 4. For ease of reference, portions of the door assembly 10 have been omitted from FIGS. 9 and 10. An emergency actuator 130 is located at the secure side 28 of the door 12, see FIG. 1. The emergency actuator 130 may be mounted on the door frame 18 and/or the wall adjacent to the door 12. In this illustrative embodiment, the emergency actuator 130 includes an emergency actuator handle 132 coupled to a lever 134 which is movably coupled to a bracket 136 by a pivot pin 138. The lever 134 has a notch 140 forming an emergency actuator latch which is configured to capture and maintain the first blocking member 102 in the unsecured orientation until the security device 100 is activated. The lever 134 may be biased by a biasing member, such as a spring for example, to hold the lever 134 in position to maintain the first blocking member 102 in the notch 140 until the security device 100 is activated. The emergency actuator 130 also has a pin 142 that is biased by a spring 144 to push against the first blocking member 102. In other embodiments, pin 142 may be biased by another biasing member.

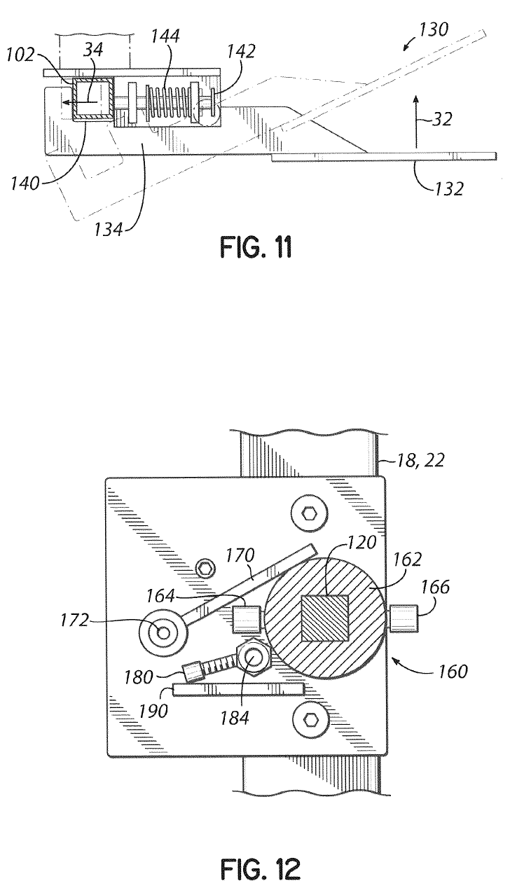

FIG. 11 is a top view of the emergency actuator 130. Referring to FIGS. 9-11, the strike plate 132 is configured to be pushed by a user in the direction of arrow 32 to activate the security device 100. In this illustrative embodiment, the emergency actuator handle 132 is configured as a strike plate. In other embodiments, the emergency actuator handle 132 and lever 134 may include a pad, a button, a handle, or any other structure configured to be operated by a user to activate the security device 100. When the security device 100 is activated, the spring 144 pushes the pin 142 which pushes against the first blocking member 102 which causes the first and second blocking members 102, 110 to rotate, indicated by arrows 34 and 36, into the secured orientation, see FIGS. 3 and 4. In this illustrative embodiment, once the first and second blocking members 102, 110 rotate about 10° from vertical the first and second blocking members 102, 110 fall into the secured orientation due to gravity. In some embodiments, the first and second blocking members 102, 110 may be biased by a biasing member or force biasing device, such as a spring for example, into the secured orientation.

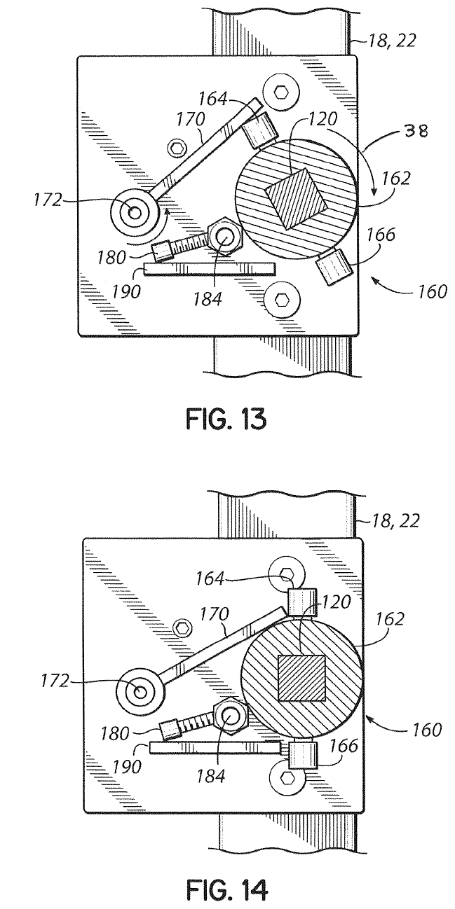

FIGS. 12, 13, and 14 are elevation views of a portion of the security device 100 showing the progressive operation of a security latch 160. For ease of reference, portions of the door assembly 10 have been omitted from FIGS. 12-14. The security device 100 has a security latch 160 that when activated, secures the first and second blocking members 102, 110 in the secured orientation, see FIGS. 3 and 4. The security latch 160 includes a cam 162, a security catch 170, a catch release 180, and a rotation stop 190. The cam 162 is mounted on the blocking member shaft 120 and includes a first cam stop 164 and a second cam stop 166. The security catch 170 rotates on a catch shaft 172. The catch release 180 is coupled to a catch release handle 182 by a catch release shaft 184 which extends through the door frame 18 and/or the wall adjacent to the door 12.

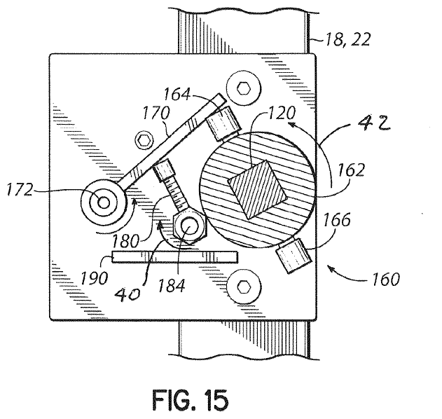

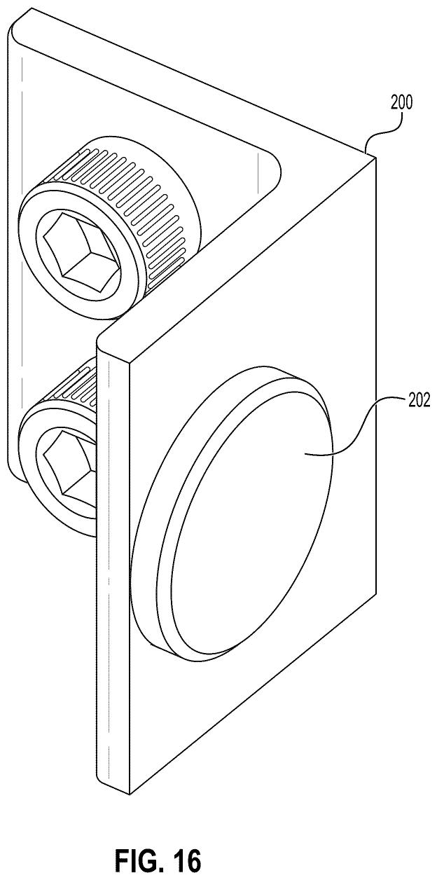

In this illustrative embodiment, as the first and second blocking members 102, 110 rotate from the unsecured orientation to the secured orientation, see FIGS. 1, 3, 9 and 10, the cam 162 rotates with blocking member shaft 120 as shown by arrow 38 in FIG. 13. The security catch 170 is gravity operated. In other embodiments, the security catch may be biased by a biasing member, such as a spring for example. As the first and second blocking members 102, 110 move from the unsecured orientation to the secured orientation, the security catch 170 moves from the unlatched position shown in FIG. 12 to the latched position shown in FIG. 14. As the first and second blocking members 102, 110 move from the unsecured orientation to the secured orientation, the second cam stop 166 engages the rotation stop 190 which prevents the first and second blocking members 102, 110, from rotating beyond the secured orientation. The security catch 170 engages the first cam stop 164 and prevents the first and second blocking members 102, 110 from moving from the secured orientation back to the unsecured orientation.

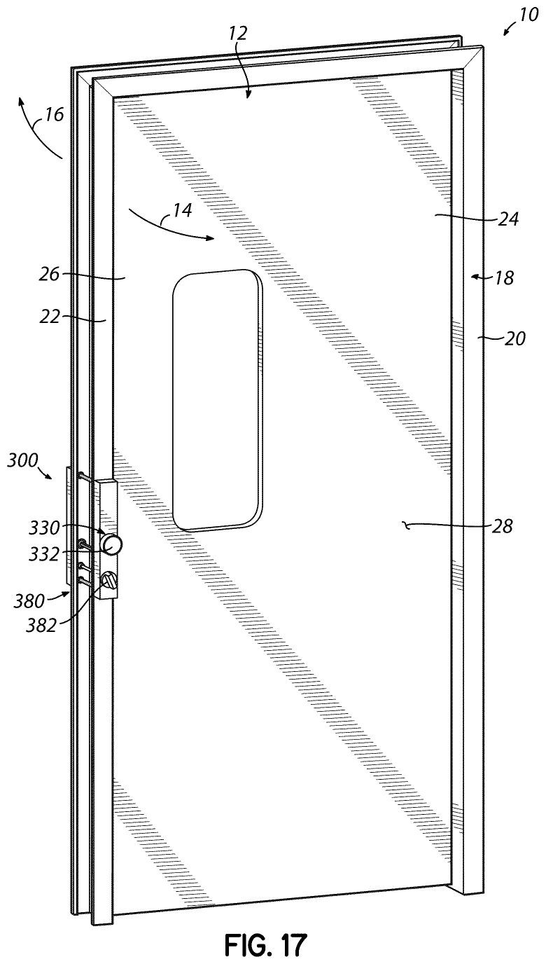

FIG. 15 is an elevation view of a portion of the security device 100 including the security latch 160. Releasing the security catch 170 allows the first and second blocking members 102, 110 to be moved from the secured orientation to the unsecured orientation. The security catch 170 is configured to be released from the secure side 28 of the door 12 by turning the catch release handle 182, see FIG. 1. As the catch release handle 182 is turned, the catch release shaft 184 rotates, as shown by arrow 40, the catch release 180 which lifts the security catch 170 above the first cam stop 164. When the security catch 170 above the first cam stop 164, the first and second blocking members 102, 110 may be rotated, as shown by arrow 42, and returned to the unsecured orientation and the first blocking member 102 returned to the notch 140 in the lever 134 of the emergency actuator 130. After the first and second blocking members 102, 110 are secured in the unsecured orientation by the emergency actuator 130 the security device 100 is reset and ready to be actuated.

The security latch 160 also has a lock mechanism 186, see FIGS. 2 and 6, which is configured to be operated from the unsecure side 30 of the door 12 and configured to release the security latch 160 when the lock mechanism 186 is actuated. In this illustrative embodiment, the lock mechanism 186 is a keyed lock. In other embodiment, lock mechanism 186 may be other types of locks. Actuating lock mechanism 186 rotates the catch release 180 which lifts the security catch 170 above the first cam stop 164. As described above, when the security catch 170 above the first cam stop 164, the first and second blocking members 102, 110 may be returned to the unsecured orientation.

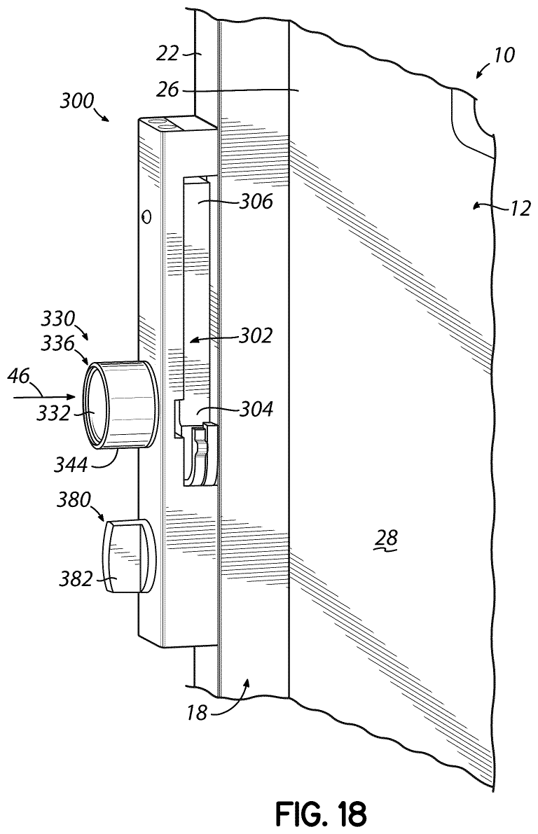

In some embodiments, the security device 100 may have a stop bracket 200 with a magnet 202 to hold the first and second blocking members 102, 110 in the unsecured orientation until activated by a user, see FIGS. 2 and 16. In an emergency, the first and second blocking members 102, 110 may be pulled down, overcoming the magnetic force of the magnet 202, to secure the door 12.

A method of securing a door 12 includes moving a first blocking member 102 located on the secure side 28 of the door 12 from an unsecured orientation to a secured orientation and moving a second blocking member 110 located on the unsecure side 30 of the door 12 from an unsecured orientation to a secured orientation. The method includes activating a security latch 170 and securing the first and second blocking members 102, 110 in the secured orientation thereby preventing the door 12 from opening. Actuating an emergency actuator 130 allows the first and second blocking members 102, 110 move from the unsecured orientation to the secured orientation. Actuating an emergency actuator 130 may include moving the emergency actuator handle 132. Moving the emergency actuator handle 132 may include pushing the emergency actuator handle 132. Releasing security latch 170 allows the first and second blocking members to move from the unsecured orientation to the secured orientation. Activating a biasing member or force biasing device 144 moves the first and second blocking members 102, 110 into the secured orientation. Releasing the security latch 170 from the secure side 28 of the door 12 allows the first and second blocking members 102, 110 to be moved from the secured orientation to the unsecured orientation. Releasing the security latch from the unsecure side 30 of the door 12 allows the first and second blocking members to be moved from the secured orientation to the unsecured orientation. An actuated lock mechanism 186 may release the security latch 170 from the unsecure side 30 of the door 12.

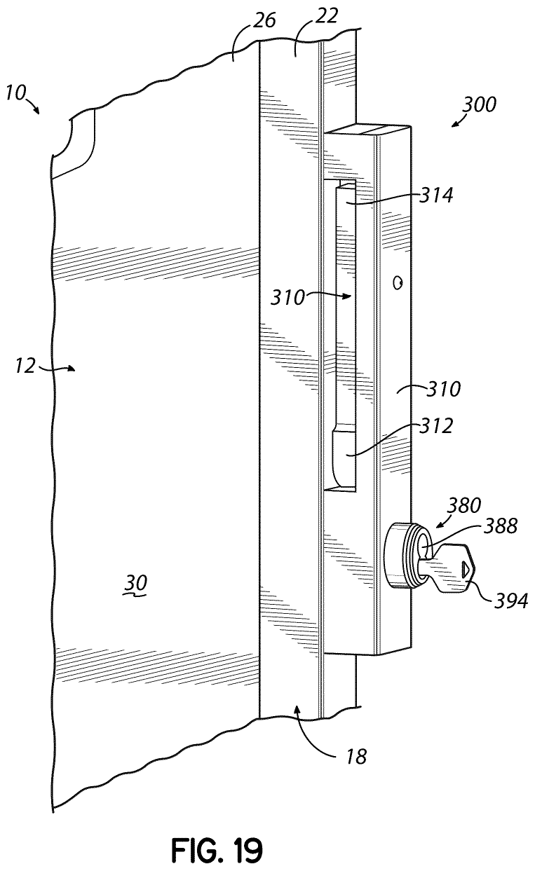

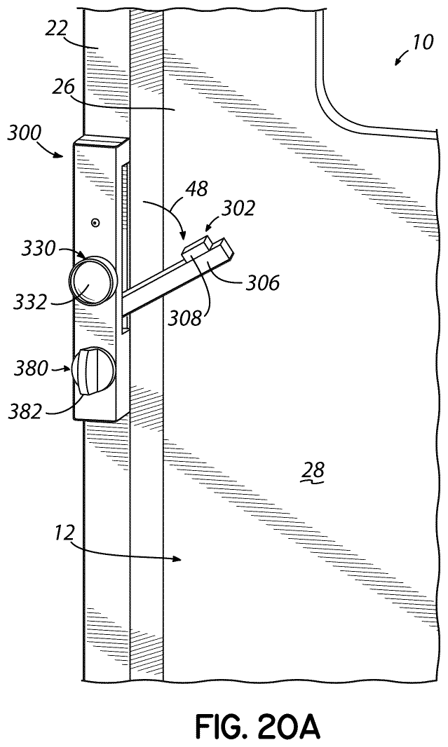

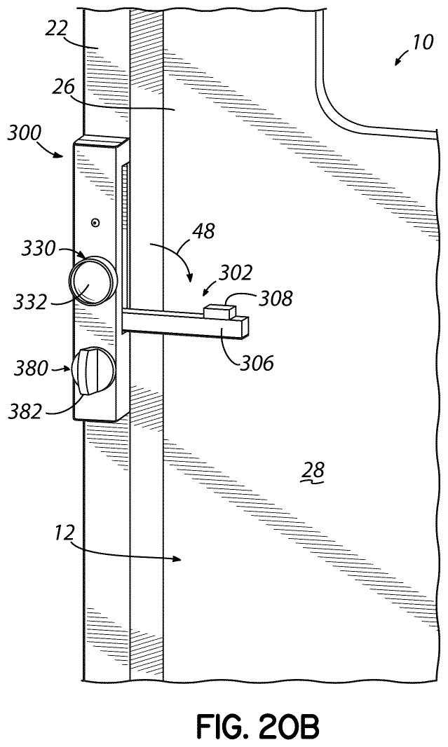

FIG. 17 is a perspective view of an illustrative door assembly 10 in a closed position and an alternative illustrative security device 300 in an unsecured condition. FIGS. 18 and 19 are partial perspective views of the door assembly 10 in a closed position and the security device 300 in the unsecured condition. The security device 300 allows normal operation of a door 12, i.e. the door 12 is free to swing open in two directions, indicated by arrows 14 and 16, and return to the closed position when the security device 300 is in the unsecured condition. Generally, the security device 300 is similar in construction and operation to the security device 100 described above and may be substituted for other security devices, or any feature of the security device 300 may be used, in various other embodiments according to the present disclosure.

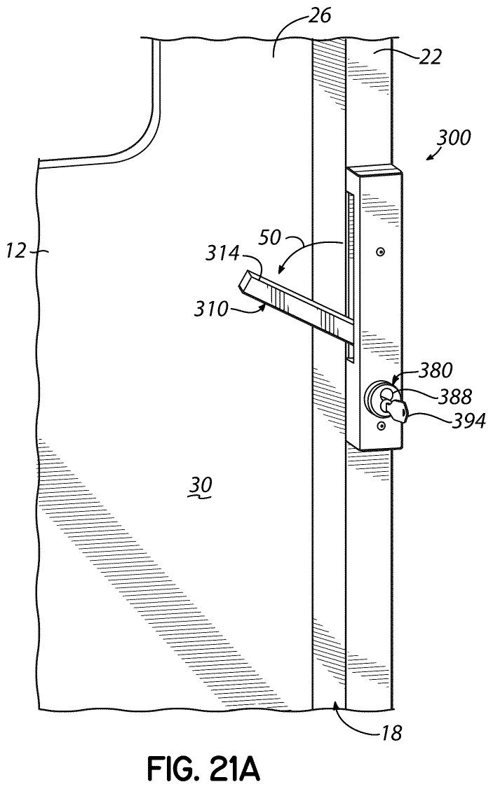

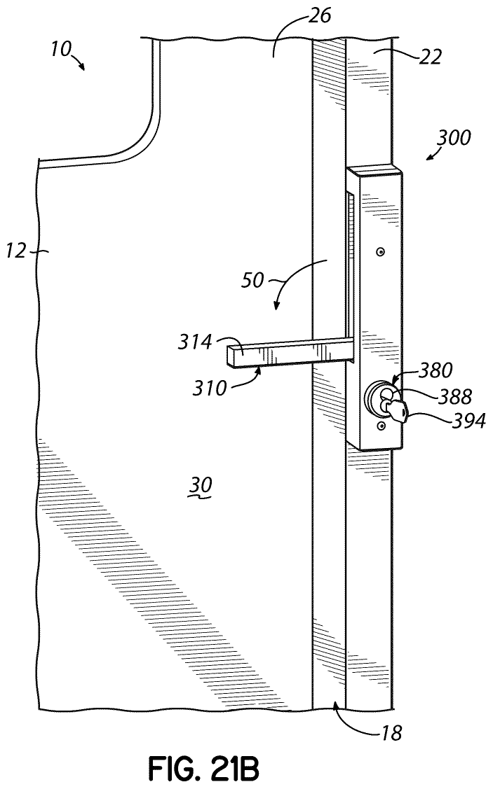

In addition to the door 12, the door assembly 10 includes a door frame 18 with a hinge side 20 and a non-hinge side 22. The door 12 includes a hinge side 24, a non-hinge side 26, a first side or secure side 28 and a second side or unsecure side 30. FIGS. 20A and 21A are partial perspective views of the door assembly 10 illustrating the security device 300 moving from the unsecured condition to a secured condition. FIGS. 20A, 20B, 21A, and 21B are partial perspective views of the door assembly 10 with the security device 300 in a secured condition. The security device 300 maintains the door 12 in the closed position and prevents the door 12 from opening when the security device 300 is in a secured condition. The security device 300 may be mounted on the door frame 18 and/or the wall adjacent to the door 12.

The unsecure side 30 of the door 12 may refer to the side of the door 12 that faces an area of a building that is open to the public such as the dining area or retail space of a restaurant or coffee shop, for example. The secure side 28 of the door 12 may refer to the side of the door 12 that faces an area of a building that is not open to the public such as a kitchen or office area, for example. When the security device 300 is in a secured condition, the door 12 is maintained in the closed position and people are prevented from readily accessing the area on the secure side 28 of the door 12. In an emergency situation, such as an active shooter event, employees and customers, for example, may go to the secure side 28 of the door 12 and secure the door 12 by activating the security device 300. The employees and customers would then be in a safe place from the danger and may have additional time to further escape the building through a back door, for example.

The security device 300 includes a first blocking member 302 located on the secure side 28 of the door 12 and a second blocking member 310 located on the unsecure side 30 of the door 12. The first and second blocking members 302, 310 are configured to move between an unsecured orientation as shown in FIGS. 17, 18, and 19 and a secured orientation as shown in FIGS. 20A and 21A and in FIGS. 20B and 21B. It should be understood that while FIGS. 20A and 21A show the first and second blocking members 302, 310 in an angled orientation, and FIGS. 20B and 21B show the first and second blocking members 302, 310 in a generally horizontal orientation, the first and second blocking members 302, 310 may be in a secured orientation whenever the first and second blocking members 302, 310 prevent the door 12 from opening. The first elongate blocking member 302 also has a sensor 308 configured to be connected to an alarm system and send a signal to the alarm system when the security device 300 is activated. Activating an alarm system when the security device 300 is activated may scare off a criminal or alert first responders of a situation requiring intervention by authorities. In alternative embodiments, the sensor 308 may be located on other portions of the security device.

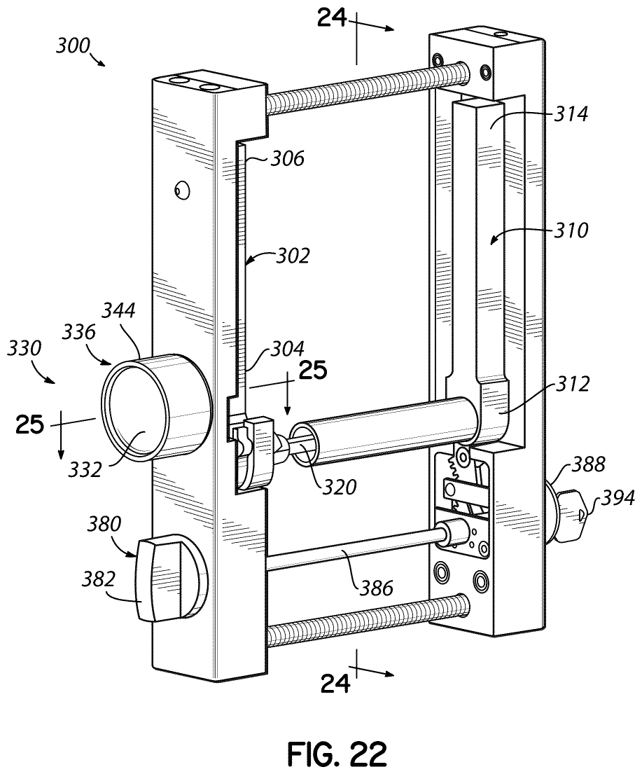

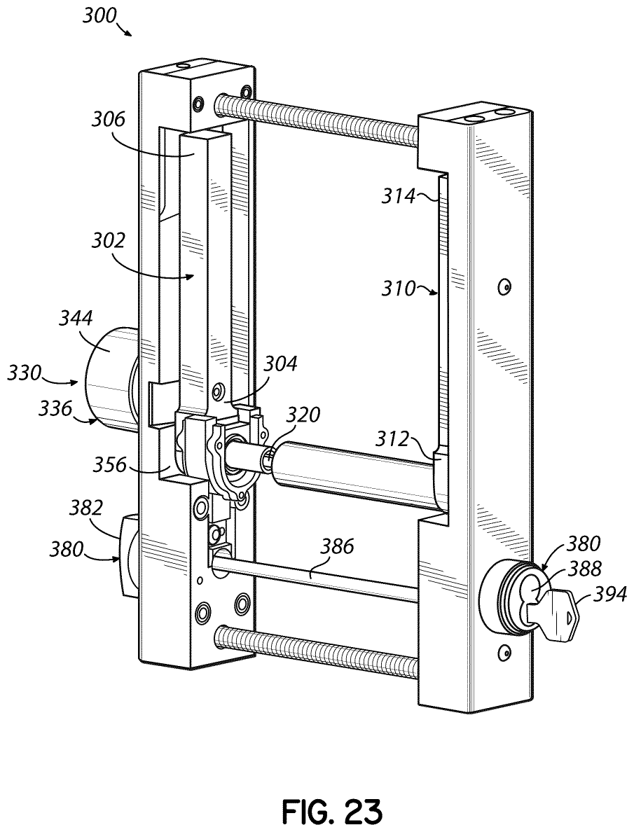

FIGS. 22 and 23 are perspective views of the security device 300 with the first and second blocking members 302, 310 in the unsecured orientation. For ease of reference, the door assembly has been omitted from FIGS. 22 and 23. The first blocking member 302 has a proximal end portion 304 and a distal end portion 306. The second blocking member 310 has a proximal end portion 312 and a distal end portion 314. The proximal end portion 304 of the first blocking member 302 is coupled to the proximal end portion 312 of the second blocking member 310 by a blocking member shaft assembly 320. The blocking member shaft assembly 320 couples the first and second blocking members 302, 310 through the door frame and/or the wall adjacent to the door. The first and second blocking members 302, 310 are coupled together such that they move between the unsecured orientation and a secured orientation simultaneously.

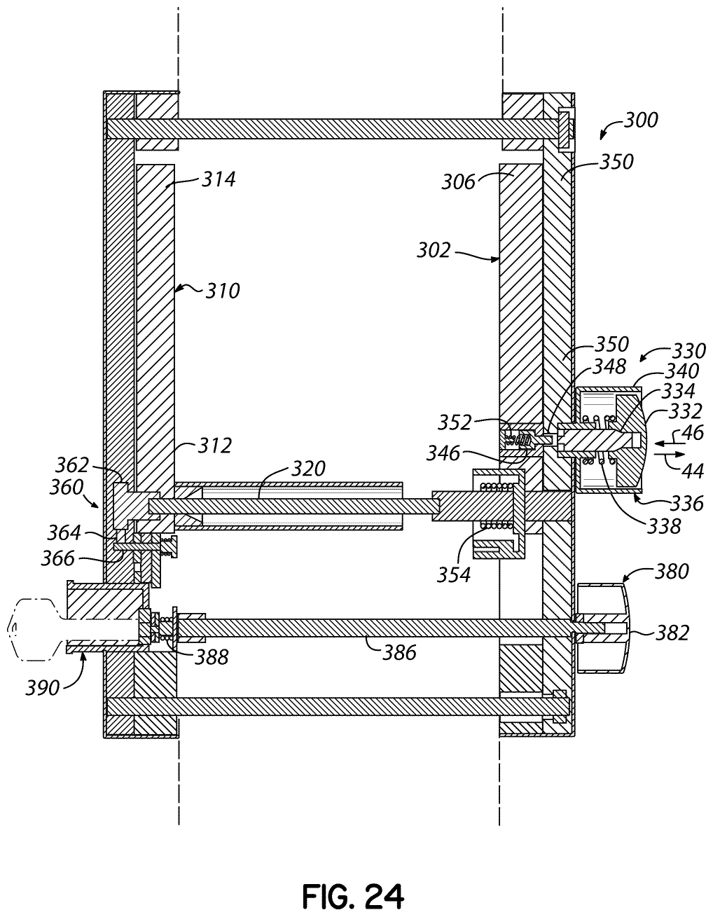

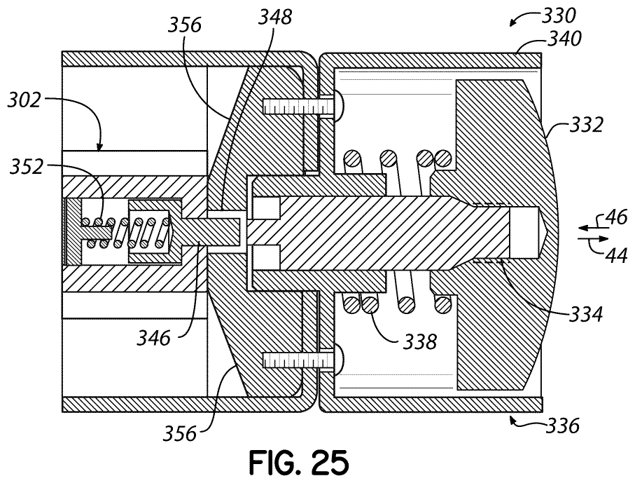

An emergency actuator 330 is located at the secure side 28 of the door 12, see FIGS. 17 and 18. FIG. 24 is a section view of the security device 300 and FIG. 25 is a partial section view of the security device 300. In this illustrative embodiment, the emergency actuator 330 includes an actuator push button 332 coupled to an actuator shaft 334. The actuator shaft 334 is movably coupled in a housing 336. The actuator shaft 334 and actuator push button 332 are biased by a biasing member or force biasing device 338, such as a coil spring, for example. The force biasing device 338 biases the actuator shaft 334 and actuator push button 332 in the direction of arrow 44. The housing 336 has a guard portion 340 surrounding the actuator push button 332 which helps to prevent the accidental depression of the actuator push button 332 and accidental actuation of the emergency actuator 330. In other embodiments, the emergency actuator 330 may include a pad, a button, a handle, or any other structure configured to be operated by a user to activate the security device 300.

The first blocking member 302 has an latch pin 346 which engages a notch or hole 348 in the secure side housing 350 and maintains the first and second blocking members 302, 310 in the unsecured orientation until the security device 300 is activated. The latch pin 346 is biased by a biasing member 352, such as a spring for example. The biasing member 352 maintains the latch pin 346 in the hole 348 until the security device 300 is activated. The biasing member 352 also pushes the latch pin 346 into the hole 348 when the security device 300 is reset. The secure side housing 350 includes sloped portions 356. When the security device 300 is reset by moving the first and second blocking members 302, 310 from a secured orientation to the unsecured orientation, the latch pin 346 engages a sloped portion 356 and is depressed into the first blocking member 302 until the latch pin 346 is aligned with the notch or hole 348 in the secure side housing 350. Once the latch pin 346 is aligned with the notch or hole 348, the biasing member 352 moves the latch pin 346 into the notch or hole 348 thereby maintaining the first and second blocking members 302, 310 in the unsecured orientation until the security device 300 is activated. In this illustrative embodiment, there are two sloped portions 356 which allow the security device to be configured for left or right hand door installation and operation.

The actuator push button 332 is configured to be pushed by a user in the direction of arrow 46, see FIGS. 18, 24, and 25, which activates the security device 300. Pushing the actuator push button 332 moves the actuator shaft 334 thereby moving the latch pin 346 out of the hole 348 and activating the security device 300. When the security device 300 is activated, a torsion spring 354, see FIG. 24, acts against the shaft assembly 320 causing the first and second blocking members 302, 310 to rotate from the unsecure orientation shown in FIGS. 17, 18, and 19, in the direction of arrows 48 and 50 shown in FIGS. 20A and 21A, into a secured orientation, see FIGS. 20A, 20B, 21A and 21B.

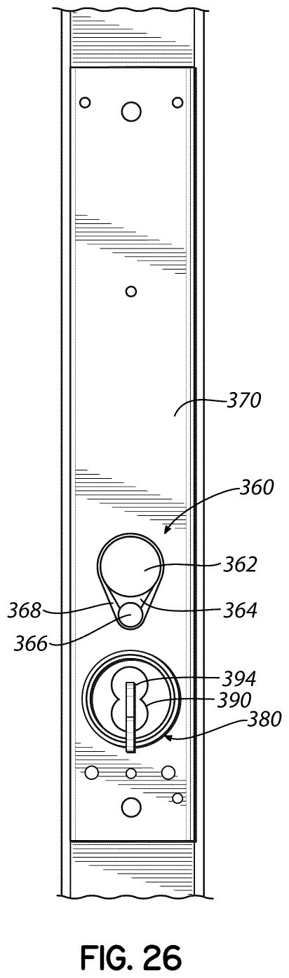

FIG. 26 is an elevation view of a portion of the security device 300, less an outer cover 310, from the unsecure side 30 of the door 12, see FIG. 19. The security device 300 has a security latch 360 that when activated, secures the first and second blocking members 302, 310 in a secured orientation, see FIGS. 20A, 20B, 21A and 21B. The security latch 360 includes a ratchet 362 and a pawl 364. The ratchet 362 is coupled to the blocking member shaft assembly 320. The pawl 364 is activated by a shaft 366 coupled to a latch actuation gear 372. The ratchet 362 and the pawl 364 operate in a recess 368 in the unsecure side housing 370. When the security latch 360 is activated, the pawl 364 engages the ratchet 362 preventing the blocking members 302, 310 from moving from a secured orientation to the unsecured orientation. The security latch 360 includes a biasing member 374 which activates the security latch 360 by maintaining the shaft 366 in a position that engages the pawl 364 with the ratchet 362. In this illustrative embodiment, when the security latch 360 is activated, after the first and second blocking members 302, 310 rotate from the unsecured orientation, the security latch 360 prevents the first and second blocking members 302, 310 from rotating back to the unsecured orientation. In this illustrative embodiment, the security latch 360 allow the first and second blocking members 302, 310 to have a plurality of secured orientations to secure the door 12. When the security latch 360 is deactivated, a user may rotate the first and second blocking members 302, 310 back to the unsecured orientation.

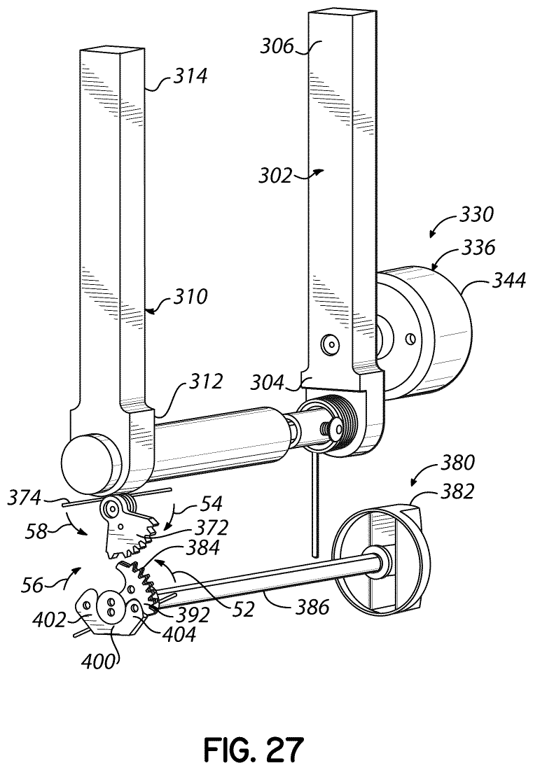

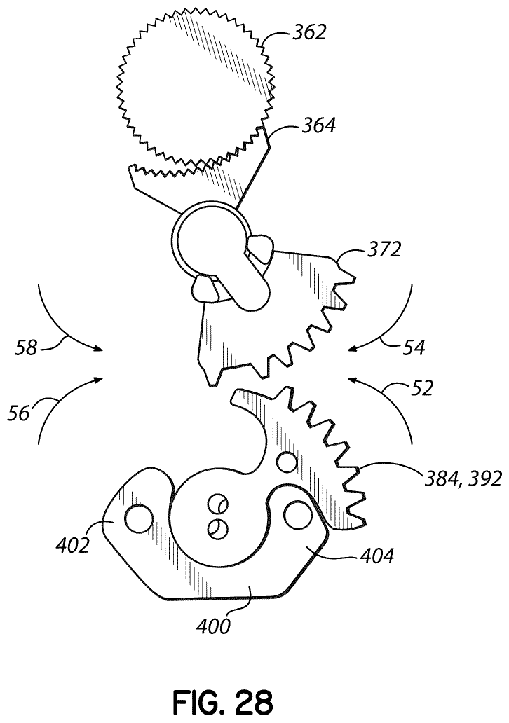

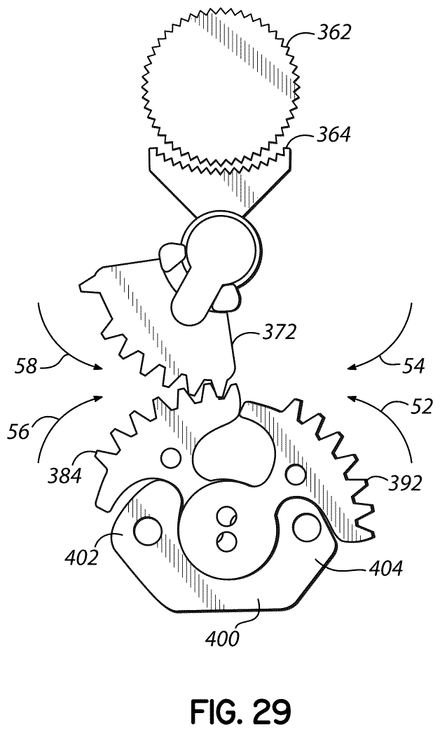

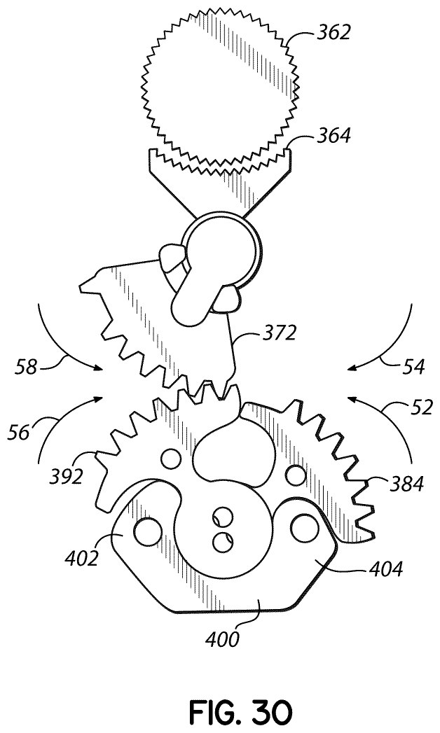

FIGS. 27, 28, 29, and 30 are partial elevation views of a portion of the security device 300 detailing portions of the latch release 380 which allows a user to deactivate or release the security latch 360 and to return the first and second blocking members 302, 310 from a secured orientation to the unsecured orientation. The latch release 380 includes a latch release handle 382 which allows a user to release the security latch 360 from the secure side 28 of the door 12. The latch release handle 382 is coupled to a first latch release gear 384 by a latch release shaft assembly 386 which extends through the door frame 18 and/or the wall adjacent to the door 12. The latch release 380 includes a biasing member 388 which biases the first latch release gear 384 and latch release shaft assembly 386. The first latch release gear 384 is arranged to selectively engage the latch actuation gear 372. Rotating the latch release handle 382 rotates the first latch release gear 384 in a first direction, indicated by arrow 52, which engages with and rotates the latch actuation gear 372 in a first direction, indicated by arrow 54. The rotation stop portion 402 of the gear stop 400 prevents overtravel of the first latch release gear 384 in the first direction. Rotating the latch actuation gear 372 in the first direction rotates the shaft 366 which causes the pawl 364 to disengage from the ratchet 362 allowing the first and second blocking members 302, 310 to be rotated or moved back to the unsecured orientation. Releasing the latch release handle 382 allows the force biasing device 388 to rotate the first latch release gear 384 in a second direction, indicated by arrow 56, which rotates the latch actuation gear 372 in a second direction, indicated by arrow 58, and then disengage the first latch release gear 384 from the latch actuation gear 372. The return stop portion 404 of the gear stop 400 prevents overtravel of the first latch release gear 384 in the second direction. Rotating the latch actuation gear 372 in the second direction rotates the shaft 366 in a second direction, indicated by arrow 58, which causes the pawl 364 to engage the ratchet 362 thereby activating the security latch 360.

The latch release 380 also has a lock mechanism 390 which may be operated from the unsecure side 30 of the door 12 to deactivate or release the security latch 360 when the lock mechanism 390 is actuated. In this illustrative embodiment, the lock mechanism 390 is a keyed lock. In other embodiments, the lock mechanism 390 may be other types of locks. The lock mechanism 390 is coupled to a second latch release gear 392 coupled to the lock mechanism 390. The second latch release gear 392 is arranged to selectively engage the latch actuation gear 372. Actuating the lock mechanism 390 with a removable key 394 rotates the second latch release gear 392 in a first direction, indicated by arrow 52, which engages with and rotates the latch actuation gear 372 in the first direction, indicated by arrow 54. The rotation stop portion 402 of the gear stop 400 prevents overtravel of the second latch release gear 392 in the first direction. As previously stated, rotating the latch actuation gear 372 in the first direction rotates the shaft 366 in a first direction which causes the pawl 364 to disengage from the ratchet 362 allowing the first and second blocking members 302, 310 to be rotated or moved back to the unsecured orientation. The lock mechanism 390 includes a biasing member which rotates the second latch release gear 392 in a second direction, indicated by arrow 56, when the key 394 is released. The return stop portion 404 of the gear stop 400 prevents overtravel of the second latch release gear 392 in the second direction. When the second latch release gear 392 rotates in the second direction, the second latch release gear 392 rotates the latch actuation gear 372 in a second direction, and then disengage the second latch release gear 392 from the latch actuation gear 372. Rotating the latch actuation gear 372 in the second direction rotates the shaft 366 in a second direction, indicated by arrow 58, which causes the pawl 364 to engage the ratchet 362 thereby activating the security latch 360.

A method of securing a door 12 includes moving a first blocking member 302 located on the secure side 28 of the door 12 from an unsecured orientation to a secured orientation and moving a second blocking member 310 located on the unsecure side 30 of the door 12 from an unsecured orientation to a secured orientation. The method includes activating a security latch 170 and securing the first and second blocking members 302, 310 in the secured orientation thereby preventing the door 12 from opening. Actuating an emergency actuator 330 allows the first and second blocking members 302, 310 move from the unsecured orientation to the secured orientation. Actuating an emergency actuator 330 may include moving the actuator push button 332. Moving the actuator push button 332 may include pushing the actuator push button 332. Releasing security latch 170 allows the first and second blocking members to move from the unsecured orientation to the secured orientation. Activating a force biasing device 144 moves the first and second blocking members 302, 310 into the secured orientation. Releasing the security latch 170 from the secure side 28 of the door 12 allows the first and second blocking members 302, 310 to be moved from the secured orientation to the unsecured orientation. Releasing the security latch from the unsecure side 30 of the door 12 allows the first and second blocking members to be moved from the secured orientation to the unsecured orientation. An actuated lock mechanism 390 may release the security latch 170 from the unsecure side 30 of the door 12.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A device for securing a door, the device comprising:
a blocking member configured to be located adjacent to the door and to move between a blocking member unsecured orientation and a blocking member secured orientation; and
an emergency actuator associated with the blocking member;
wherein the door is free to open and close when the blocking member is in the blocking member unsecured orientation,
wherein the blocking member moves from the blocking member unsecured orientation to the blocking member secured orientation when the emergency actuator is actuated, and
wherein the door is prevented from opening when the blocking member is in the blocking member secured orientation.

2. The device of claim 1, wherein the blocking member secured orientation comprises a plurality of blocking member secured orientations.

3. The device of claim 1, further comprising a security latch associated with the blocking member;
wherein when activated, the security latch maintains the blocking member in the blocking member secured orientation.

4. The device of claim 3, wherein moving the blocking member into the blocking member secured orientation activates the security latch.

5. The device of claim 3, wherein releasing the security latch allows the blocking member to be moved from the blocking member secured orientation to the blocking member unsecured orientation.

6. The device of claim 3, further comprising a security latch release actuator associated with the security latch and configured to release the security latch when the security latch release actuator is actuated.

7. The device of claim 3, further comprising a lock mechanism associated with the security latch and configured to release the security latch when the lock mechanism is actuated.

8. The device of claim 7, wherein the lock mechanism comprises a keyed lock.

9. The device of claim 3, wherein the security latch further comprises:
a ratchet; and
a pawl configured to engage the ratchet;
wherein moving the blocking member from the blocking member unsecured orientation to the blocking member secured orientation rotates the ratchet in a first ratchet direction and the pawl engages the ratchet preventing the ratchet from rotating in a second ratchet direction, the second ratchet direction being opposite the first ratchet direction, thereby preventing the blocking member from moving to the blocking member unsecured orientation.

10. The device of claim 9, wherein disengaging the pawl from the ratchet allows the ratchet to rotate in the second ratchet direction thereby allowing the blocking member to be moved to the blocking member unsecured orientation.

11. The device of claim 1, wherein the emergency actuator comprises an emergency actuator latch;
wherein the emergency actuator latch maintains the blocking member in the blocking member unsecured orientation and actuating the emergency actuator releases the emergency actuator latch allowing the blocking member to move to the blocking member secured orientation.

12. The device of claim 1, further comprising a force biasing device configured to bias the blocking member to the blocking member secured orientation.

13. The device of claim 12, wherein the force biasing device comprises a spring.

14. The device of claim 1, further comprising at least one of a sensor or a switch configured to send a signal to an alarm system when the blocking member is in the blocking member secured orientation.

15. The device of claim 1, wherein the blocking member is a first blocking member configured to be located adjacent to a first side of the door and to move between a first blocking member unsecured orientation and a first blocking member secured orientation, and the device further comprises:
a second blocking member configured to be located adjacent to a second side of the door and to move between a second blocking member unsecured orientation and a second blocking member secured orientation;
wherein the door is free to open and close when the first blocking member is in the first blocking member unsecured orientation and the second blocking member is in the second blocking member unsecured orientation, and
wherein the door is prevented from opening when the first blocking member is in the first blocking member secured orientation and the second blocking member is in the second blocking member secured orientation.

16. A device for securing a door, the device comprising:
a first blocking member configured to be located adjacent to a first side of the door and o move between a first blocking member unsecured orientation and a first blocking member secured orientation; and
a second blocking member configured to be located adjacent to a second side of the door and to move between a second blocking member unsecured orientation and a second blocking member secured orientation;
wherein the door is free to open and close when the first blocking member is in the first blocking member unsecured orientation and the second blocking member is in the second blocking member unsecured orientation, and
wherein the door is prevented from opening when the first blocking member is in the first blocking member secured orientation and the second blocking member is in the second blocking member secured orientation.

17. The device of claim 16, wherein the first blocking member secured orientation comprises a plurality of first blocking member secured orientations, and
wherein the second blocking member secured orientation comprises a plurality of second blocking member secured orientations.

18. The device of claim 16, further comprising a security latch associated with at least one of the first blocking member or the second blocking member;
wherein when activated, the security latch maintains at least one of the first blocking member in the first blocking member secured orientation or the second blocking member in the second blocking member secured orientation.

19. The device of claim 18, wherein moving at least one of the first blocking member into the first blocking member secured orientation or the second blocking member into the second blocking member secured orientation activates the security latch.

20. The device of claim 18, wherein releasing the security latch allows at least one of the first blocking member to be moved from the first blocking member secured orientation to the first blocking member unsecured orientation or the second blocking member to be moved from the second blocking member secured orientation to the second blocking member unsecured orientation.

21. The device of claim 18, further comprising a security latch release actuator associated with the security latch and configured to release the security latch when the security latch release actuator is actuated.

22. The device of claim 18, further comprising a lock mechanism associated with the security latch and configured to release the security latch when the lock mechanism is actuated.

23. The device of claim 22, wherein the lock mechanism comprises a keyed lock.

24. The device of claim 18, wherein the security latch further comprises:
a ratchet; and
a pawl configured to engage the ratchet;
wherein moving at least one of the first blocking member from the first blocking member unsecured orientation to the first blocking member secured orientation or the second blocking member from the second blocking member unsecured orientation to the second blocking member secured orientation rotates the ratchet in a first ratchet direction and the pawl engages the ratchet preventing the ratchet from rotating in a second ratchet direction, the second ratchet direction being opposite the first ratchet direction, thereby preventing at least one of the first blocking member from moving to the first blocking member unsecured orientation or the second blocking member from moving to the second blocking member unsecured orientation.

25. The device of claim 24, wherein disengaging the pawl from the ratchet allows the ratchet to rotate in the second ratchet direction thereby allowing at least one of the first blocking member to be moved to the first blocking member unsecured orientation or the second blocking member to be moved to the second blocking member unsecured orientation.

26. The device of claim 16, further comprising an emergency actuator associated with the first blocking member and the second blocking member;
wherein the first blocking member moves from the first blocking member unsecured orientation to the first blocking member secured orientation and the second blocking member moves from the second blocking member unsecured orientation to the second blocking member secured orientation when the emergency actuator is actuated.

27. The device of claim 26, wherein the emergency actuator comprises an emergency actuator latch;
wherein the emergency actuator latch maintains at least one of the first blocking member in the first blocking member unsecured orientation or the second blocking member in the second blocking member unsecured orientation and actuating the emergency actuator releases the emergency actuator latch allowing at least one of the first blocking member to move to the first blocking member secured orientation or the second blocking member to move to the second blocking member secured orientation.

28. The device of claim 16, further comprising a force biasing device configured to bias at least one of the first blocking member to the first blocking member secured orientation or the second blocking member to the second blocking member secured orientation.

29. The device of claim 28, wherein the force biasing device comprises a spring.

30. The device of claim 16, further comprising at least one of a sensor or a switch configured to send a signal to an alarm system when at least one of the first blocking member is in the first blocking member secured orientation or the second blocking member is in the second blocking member secured orientation.

31. A device for securing a door, the device comprising:
a first blocking member configured to be located adjacent to a first side of the door and to move between a first blocking member unsecured orientation and a first blocking member secured orientation;
a second blocking member configured to be located adjacent to a second side of the door and to move between a second blocking member unsecured orientation and a second blocking member secured orientation;
an emergency actuator associated with the first blocking member and the second blocking member; and
a security latch associated with the first blocking member and the second blocking member;
wherein the door is free to open and close when the first blocking member is in the first blocking member unsecured orientation and the second blocking member is in the second blocking member unsecured orientation,
wherein the first blocking member moves from the first blocking member unsecured orientation to the first blocking member secured orientation and the second blocking member moves from the second blocking member unsecured orientation to the second blocking member secured orientation when the emergency actuator is actuated,
wherein the door is prevented from opening when the first blocking member is in the first blocking member secured orientation and the second blocking member is in the second blocking member secured orientation,
wherein moving the first blocking member into the first blocking member secured orientation and the second blocking member into the second blocking member secured orientation activates the security latch and the security latch maintains the first blocking member in the first blocking member secured orientation and the second blocking member in the second blocking member secured orientation, and
wherein releasing the security latch allows the first blocking member to be moved from the first blocking member secured orientation to the first blocking member unsecured orientation and the second blocking member to be moved from the second blocking member secured orientation to the second blocking member unsecured orientation.

32. The device of claim 31, wherein the first blocking member secured orientation comprises a plurality of first blocking member secured orientations, and
wherein the second blocking member secured orientation comprises a plurality of second blocking member secured orientations.

33. The device of claim 31, further comprising a security latch release actuator associated with the security latch and configured to release the security latch when the security latch release actuator is actuated.

34. The device of claim 31, further comprising a lock mechanism associated with the security latch and configured to release the security latch when the lock mechanism is actuated.

35. The device of claim 34, wherein the lock mechanism comprises a keyed lock.

36. The device of claim 31, wherein the security latch further comprises:
a ratchet; and
a pawl configured to engage the ratchet;
wherein moving the first blocking member from the first blocking member unsecured orientation to the first blocking member secured orientation and the second blocking member from the second blocking member unsecured orientation to the second blocking member secured orientation rotates the ratchet in a first ratchet direction and the pawl engages the ratchet preventing the ratchet from rotating in a second ratchet direction, the second ratchet direction being opposite the first ratchet direction, thereby preventing the first blocking member from moving to the first blocking member unsecured orientation and the second blocking member from moving to the second blocking member unsecured orientation.

37. The device of claim 36, wherein disengaging the pawl from the ratchet allows the ratchet to rotate in the second ratchet direction thereby allowing the first blocking member to be moved to the first blocking member unsecured orientation and the second blocking member to be moved to the second blocking member unsecured orientation.

38. The device of claim 31, wherein the emergency actuator comprises an emergency actuator latch;
wherein the emergency actuator latch maintains the first blocking member in the first blocking member unsecured orientation and the second blocking member in the second blocking member unsecured orientation and actuating the emergency actuator releases the emergency actuator latch allowing the first blocking member to move to the first blocking member secured orientation and the second blocking member to move to the second blocking member secured orientation.

39. The device of claim 31, further comprising a force biasing device configured to bias the first blocking member to the first blocking member secured orientation and the second blocking member to the second blocking member secured orientation.

40. The device of claim 39, wherein the force biasing device comprises a spring.

41. The device of claim 31, further comprising at least one of a sensor or a switch configured to send a signal to an alarm system when at least one of the first blocking member is in the first blocking member secured orientation or the second blocking member is in the second blocking member secured orientation.

42. A method of securing a door, the method comprising:
moving a first blocking member located adjacent to a first side of the door to a first blocking member secured orientation;
moving a second blocking member located adjacent to a second side of the door to a second blocking member secured orientation; and
activating a security latch thereby securing the first blocking member in the first blocking member secured orientation and the second blocking member in the second blocking member secured orientation;
wherein the door is prevented from opening when the first blocking member is in the first blocking member secured orientation and the second blocking member is in the second blocking member secured orientation.

43. The method of claim 42, wherein the first blocking member secured orientation comprises a plurality of first blocking member secured orientations, and
wherein the second blocking member secured orientation comprises a plurality of second blocking member secured orientations.

44. The method of claim 42, further comprising releasing an emergency actuator latch thereby allowing the first blocking member to move to the first blocking member secured orientation and the second blocking member to move to the second blocking member secured orientation.

45. The method of claim 42, further comprising releasing the security latch thereby allowing the first blocking member to be moved to a first blocking member unsecured orientation and the second blocking member to be moved to a second blocking member unsecured orientation;
wherein the door is free to open and close when the first blocking member is in the first blocking member unsecured orientation and the second blocking member is in the second blocking member unsecured orientation.

46. The method of claim 42, further comprising sending a signal to an alarm system when the first blocking member is in the first blocking member secured orientation and the second blocking member is in the second blocking member secured orientation.
